(19) United States
(12) Patent Application Publication
(10) Pub. No.: US 2020/0290330 A1
(43) Pub. Date: Sep. 17, 2020

(54) SUPER WATER-REPELLENT FILM

(71) Applicant: Sharp Kabushiki Kaisha, Osaka (JP)

(72) Inventor: Kenichiro NAKAMATSU, Sakai City (JP)

(21) Appl. No.: 16/802,760

(22) Filed: Feb. 27, 2020

(30) Foreign Application Priority Data
Mar. 15, 2019 (JP) 2019-048797

(51) Int. Cl. B32B 27/30; B32B 3/30; B32B 27/08

(52) U.S. Cl. CPC B32B 27/308; B32B 3/30; B32B 27/08; B32B 2307/412; B32B 2307/73; B32B 2307/302; C03C 2217/76; B32B 2333/08

(57) ABSTRACT

The present invention provides a super water-repellent film having high transparency, super water repellency, and antistatic properties. The super water-repellent film includes a polymer layer including, on a surface of the polymer layer, a projection/recess structure in which projections are provided at a pitch equal to or smaller than a wavelength of visible light; and a transparent conductive particle disposed in a recess provided between the projections. The polymer layer is a cured product of a polymerizable composition containing a polyfunctional acrylate, a monofunctional acrylate, and a fluorine-containing release agent containing a perfluoropolyether group. The transparent conductive particle is disposed at a position in the recess deeper than tips of the projections. The tips are exposed on an outermost surface of the super water-repellent film.

### CROSS-REFERENCE TO RELATED APPLICATIONS

The present application claims priority under 35 U.S.C. § 119 to Japanese Patent Application No. 2019-048797 filed on Mar. 15, 2019, the contents of which are incorporated herein by reference in their entirety.

### BACKGROUND OF THE INVENTION

### Field of the Invention

The present invention relates to a super water-repellent film. More specifically, the present invention relates to a super water-repellent film having a nanometer-sized projection/recess structure.

### Description of Related Art

It is known that a film having a moth-eye structure, a kind of a nanometer-sized projection/recess structure (nanostructure), has excellent anti-reflection properties. WO 2016/056434 proposes a configuration in which a film having the moth-eye structure and metal fine particles are combined. Specifically, in a transparent conductor disclosed by WO 2016/056434, metal fine particles are placed in bottom portions of gaps between projections constituting the moth-eye structure to form mesh conductive portions, whereby excellent conductivity is exhibited with the mesh conductive portions constituted by the metal fine particles, excellent transparency (light transparency) is exhibited in regions in which metal fine particles are not placed, and an excellent low-reflection property is exhibited with the moth-eye structure. WO 2016/056434 describes that such a transparent conductor can be used as a transparent electrode in products such as touch panels in the display field.

On the other hand, in a thermoplastic resin film, an antistatic function is generally provided to lower insulating properties (to lower inherent surface resistance). For example, JP 4745342 B discloses (1) a surface-modified plastic film, comprising: a surface layer composed of minute filamentous forms consisting of a composition containing a resin and/or inorganic microparticles, on at least one major surface of a substrate plastic film containing an antistatic agent, (2) a surface-modified plastic film, comprising: a conductive film on at least one major surface of a substrate plastic film and having a surface layer composed of minute filamentous forms consisting of a composition containing a resin and/or inorganic microparticles, on the conductive film, and (3) a surface-modified plastic film, in which at least one major surface of a substrate plastic film is treated with an antistatic agent and which has a surface layer composed of minute filamentous forms consisting of a composition containing a resin and/or inorganic microparticles, on the surface.

### BRIEF SUMMARY OF THE INVENTION

By the way, the present inventors have found that a film having high transparency and very excellent water repellency (super water repellency) can be achieved by devising a constituent material having a moth-eye structure. Applying such a super water-repellent film can prevent adhesion of moisture without impairing appearance of a material. The techniques described in WO 2016/056434 and JP 4745342 B do not provide a super water-repellent film.

On the other hand, since a constituent material of the super water-repellent film has high insulating properties, static electricity is generated due to friction and is likely to be electrified. Due to the electrification, dirt such as dust, house dust, and pollen is likely to adhere and accumulate on the surface of the super water-repellent film. Therefore, in order to improve the function as the super water-repellent film, it has been required to impart antistatic properties in addition to high transparency and super water repellency.

The present invention has been made in view of the above situation, and an object of the present invention is to provide a super water-repellent film having high transparency, super water repellency, and antistatic properties.

(1) One embodiment of the present invention is a super water-repellent film including a polymer layer including on its surface a projection/recess structure in which projections are provided at a pitch equal to or smaller than a wavelength of visible light, and a transparent conductive particle disposed in a recess provided between the projections. In this super water-repellent film, the polymer layer is a cured product of a polymerizable composition containing a polyfunctional acrylate, a monofunctional acrylate, and a fluorine-containing release agent containing a perfluoropolyether group, the transparent conductive particle is disposed at a position in the recess deeper than tips of the projections, and the tips are exposed on an outermost surface of the super water-repellent film.

(2) In an embodiment of the present invention, in addition to the constitution of the above (1), the transparent conductive particle includes an indium tin oxide particle.

(3) In an embodiment of the present invention, in addition to the constitution of the above (1) or (2), the transparent conductive particle has an average particle size of 2 to 50 nm.

(4) In an embodiment of the present invention, in addition to the constitution of the above (1), (2), or (3), the projections provide an average aspect ratio of 2 or more and 5 or less.

(5) In an embodiment of the present invention, in addition to the constitution of the above (1), (2), (3), or (4), the monofunctional acrylate contains at least one of N-acryloylmorpholine or N, N-dimethylacrylamide.

According to the present invention, it is possible to provide a super water-repellent film having high transparency, super water repellency and antistatic properties.

### BRIEF DESCRIPTION OF THE DRAWINGS

FIG. 1 is a schematic cross-sectional view showing a super water-repellent film of an embodiment;

FIG. 2 is a schematic plan view showing a shape of a polymer layer in FIG. 1;

FIG. 3A is a schematic cross-sectional view showing the super water-repellent film when a filling amount d of transparent conductive particles 11 is equal to a height H of a projection 4 (d=H), and FIG. 3B is a photomicrograph showing a surface condition of the super water-repellent film in the case shown in FIG. 3A (d=H);

FIG. 4A is a schematic cross-sectional view showing the super water-repellent film when the filling amount d of the transparent conductive particles 11 is about ¾ times the height H of the projection 4 (d=¾H), and FIG. 4B is a photomicrograph showing a surface condition of the super water-repellent film in the case shown in FIG. 4A (d=¾H);

FIG. 5A is a schematic cross-sectional view showing the super water-repellent film when the filling amount d of the transparent conductive particles 11 is about ½ times the height H of the projection 4 (d=½H), and FIG. 5B is a photomicrograph showing a surface condition of the super water-repellent film in the case shown in FIG. 5A (d=½H);

FIG. 6A is a schematic cross-sectional view showing the super water-repellent film when the filling amount d of the transparent conductive particles 11 is about ¼ times the height H of the projection 4 (d=¼H), and FIG. 6B is a photomicrograph showing a surface condition of the super water-repellent film in the case shown in FIG. 6A (d=¼H);

FIGS. 7A-7E are views for explaining a mechanism in which the transparent conductive particles 11 are arranged at a bottom in a recess.

FIGS. 8A-8D are schematic cross-sectional views for explaining a first example of a method of forming a polymer layer 3;

FIGS. 9A-9D are schematic cross-sectional views for explaining a second example of the method of forming the polymer layer 3;

FIGS. 10A-10D are schematic cross-sectional views for explaining a third example of the method of forming the polymer layer 3;

FIG. 11 is a schematic cross-sectional view for explaining a surface shape of a polymer layer obtained by using a second die;

FIG. 12A and FIG. 12B are micrographs showing surface conditions of the super water-repellent film having a projection with an aspect ratio of 5.7, FIG. 12A shows a surface condition before ITO ink application, and FIG. 12B shows a surface condition after ITO ink application; and

FIG. 13 is a graph showing reflection spectra of super water-repellent films of Examples 1 to 4.

### DETAILED DESCRIPTION OF THE INVENTION

Hereinafter, the present invention is described in more detail based on embodiments with reference to the drawings. The embodiments, however, are not intended to limit the scope of the present invention. The configurations of the embodiments may appropriately be combined or modified within the spirit of the present invention.

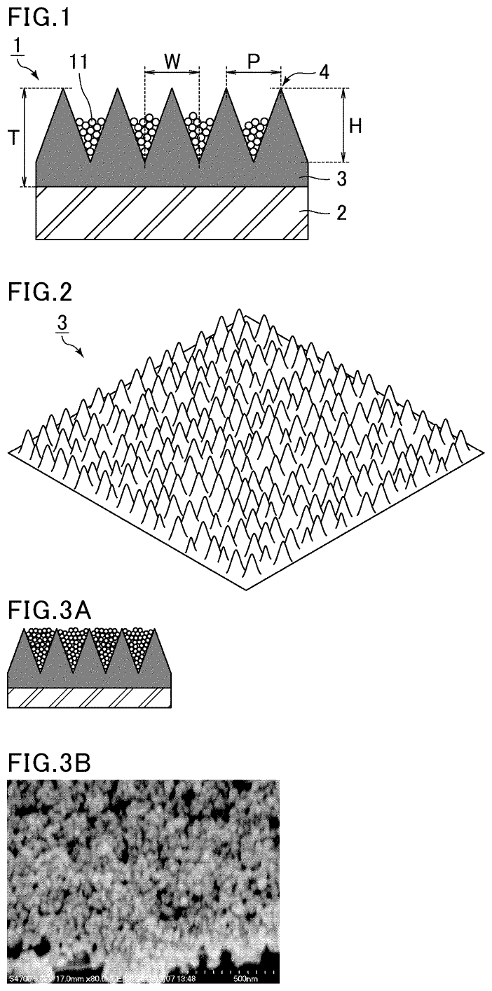

A super water-repellent film of an embodiment will be described below with reference to FIGS. 1 and 2. FIG. 1 is a schematic cross-sectional view showing the super water-repellent film of the embodiment. FIG. 2 is a schematic plan view showing a shape of a polymer layer in FIG. 1. As shown in the figure, in a super-water-repellent film 1 of the embodiment, a polymer layer 3 having a projection/recess structure on its surface is provided on a base material 2. The projection/recess structure has projections 4 provided at a pitch P equal to or smaller than a wavelength of visible light (780 nm). Here, the pitch P means a distance between vertices of the adjacent projections 4. Transparent conductive particles 11 are arranged in a recess formed between the projections 4.

<Base Material 2>

Examples of the material of the base material 2 include resins such as triacetyl cellulose (TAC), polyethylene terephthalate (PET), and methyl methacrylate (MMA). The base material 2 may appropriately contain additives such as a plasticizer in addition to the above material. One surface (the surface close to the polymer layer 3) of the base material 2 may have undergone easy adhesion treatment. For example, a triacetyl cellulose film subjected to easy adhesion treatment may be used. One surface (the surface close to the polymer layer 3) of the base material 2 may have undergone saponification treatment. For example, a saponified triacetyl cellulose film may be used. When the super water-repellent film 1 is to be attached to a display device having a polarizing plate such as a liquid crystal display device, the base material 2 may constitute a part of the polarizing plate.

In order to ensure the transparency and processability, the base material 2 preferably has a thickness of 50 μm or more and 100 μm or less.

<Polymer Layer 3>

The polymer layer 3 has on its surface a projection/recess structure in which the projections 4 are provided at the pitch P equal to or smaller than the wavelength of visible light, that is, a so-called moth-eye surface structure (moth-eye structure). The polymer layer 3 has a moth-eye structure formed of a water-repellent material on its surface, so that it is possible to greatly increase a surface contact angle of the super water-repellent film 1 with respect to a solvent such as water, hexadecane, and cyclohexane and to exhibit excellent super water repellency. When the moth-eye structure is present on the surface, surface reflection is greatly reduced, so that it is possible to exhibit excellent anti-reflection properties.

The polymer layer 3 preferably has a thickness T of 20 μm or less from the viewpoint of aligning fluorine atoms in a fluorine-containing release agent contained in the polymer layer 3 at a high concentration on the surface (the surface opposite to the base material 2) of the polymer layer 3. As shown in FIG. 1, the thickness T of the polymer layer 3 refers to a distance from the surface on the base material 2 side to the vertex of the projection 4. A preferred lower limit of the thickness T of the polymer layer 3 is 5 μm, and a more preferred lower limit is 8 μm. A more preferred upper limit of the thickness T of the polymer layer 3 is 12 μm.

The projections 4 may each have any shape, as long as the shape tapers toward the end. Examples of the shape include shapes that taper toward the end (tapered shape), such as shapes formed by a pillar-shaped bottom portion and a hemispherical top portion (bell shapes) and conical shapes (cone shapes, circular cone shapes). Although the bottoms of the gaps (recesses) between the adjacent projections 4 each are inclined in FIG. 1, the bottoms may each form a horizontal line without inclination.

An average pitch of the projections 4 is preferably 100 nm or more and 400 nm or less, more preferably 100 nm or more and 200 nm or less, from the viewpoint of sufficiently preventing optical phenomena such as a moiré pattern and iridescent unevenness. The average pitch of the projections 4 specifically refers to an average of the pitches (P in FIG. 1) of all the adjacent projections within a 1-μm square region in a 2D picture taken with a scanning electron microscope.

An average height of the projections 4 is preferably 100 nm or more and 1000 nm or less, more preferably 100 nm or more and 500 nm or less, still more preferably 100 nm or more and 300 nm or less. If the average height of the projections 4 is within the above range, it is possible to simultaneously achieve the later-described suitable average aspect ratio of the projections 4. On the other hand, if the average height of the projections 4 is too high, even when a phenomenon that fluorine atoms in the fluorine-containing release agent are attracted to a die when the die is pressed to form a moth-eye structure is used, in some cases, the fluorine atoms may not be easily aligned on the surface (the surface opposite to the base material 2) of the polymer layer 3. The average height of the projections 4 specifically refers to an average of the heights (H in FIG. 1) of 10 projections formed in a continuous row in a cross-sectional photograph taken with a scanning electron microscope. However, when 10 projections are selected, projections with a defect or deformation (portions deformed in preparation of a sample for measurement) are excluded from the 10 projections.

The average aspect ratio of the projections 4 is preferably 2 or more and 5 or less. When the average aspect ratio is less than 2, optical phenomena such as a moiré pattern and iridescent unevenness cannot be sufficiently prevented, and excellent anti-reflection properties may not be obtained. If the average aspect ratio of the projections 4 is more than 5, processability of the projection/recess structure is reduced, the projections 4 may adhere to each other (sticking), or the transfer condition for formation of the projection/recess structure may be deteriorated (e.g., a die 6 described later is clogged or wound). The average aspect ratio refers to a ratio (height/half width) between the average height of the projections 4 and an average half width.

An average width of the projections 4 is preferably 100 nm or more and 1000 nm or less, more preferably 100 nm or more and 500 nm or less, still more preferably 100 nm or more and 300 nm or less. Fluorine atoms in the fluorine-containing release agent are considered to promote movement (upward) to the surface (the surface opposite to the base material 2) of the polymer layer 3 also by the capillary action of the projections 4. Here, if the average width of the projections 4 is too large, the capillary force is weakened, so that fluorine atoms may not be easily aligned on the surface of the polymer layer 3. On the other hand, if the average width of the projections 4 is too small, the average aspect ratio of the projections 4 tends to increase, and sticking may occur. The average width of the projections 4 specifically refers to an average of the widths (W in FIG. 1) of 10 projections formed in a continuous row in a cross-sectional photograph taken with a scanning electron microscope. However, when 10 projections are selected, projections with a defect or deformation (portions deformed in preparation of a sample for measurement) are excluded from the 10 projections.

The projections 4 may be arranged either randomly or regularly (periodically). The projections 4 may be arranged with periodicity. Still, in order to successfully avoid unnecessary diffraction of light due to such periodicity, as shown in FIG. 2, the projections 4 are preferably arranged without periodicity (arranged randomly).

The polymer layer 3 is a cured product of a polymerizable composition. Examples of the polymer layer 3 include a cured product of an active energy ray-curable polymerizable composition and a cured product of a thermosetting polymerizable composition. The active energy rays herein mean ultraviolet rays, visible light, infrared rays, plasma, or the like. The polymer layer 3 is preferably a cured product of an active energy ray-curable polymerizable composition, particularly more preferably a cured product of an ultraviolet-curable polymerizable composition.

The polymerizable composition contains at least (A) a polyfunctional acrylate, (B) a monofunctional acrylate, and (C) a fluorine-containing release agent containing a perfluoropolyether group, and may contain other components.

(A) Polyfunctional Acrylate

Polyfunctional acrylate refers to an acrylate having two or more acryloyl groups per molecule. By blending the polyfunctional acrylate, a crosslink density of the polymer layer 3 is increased, and suitable hardness (elasticity) is provided, so that rubbing resistance is enhanced. The polyfunctional acrylate preferably has an ethylene oxide group from the viewpoint of rubbing resistance and adhesiveness. The rubbing resistance is considered to correlate with the crosslink density and glass transition temperature of the polymer layer 3, and when the crosslink density is increased and the glass transition temperature is reduced, the rubbing resistance can be significantly increased. For example, a polymerizable composition containing a polyfunctional acrylate having an ethylene oxide group can have a lower glass transition temperature compared to a case of containing a polyfunctional acrylate having a propylene oxide group. In the ethylene oxide group, since the propylene oxide group (the same applies to a hydrocarbon group) has a higher polarity than the ethylene oxide group and a higher interaction with the base material 2, adhesiveness (between the polymer layer 3 and the base material 2) increases.

The number of functional groups of the polyfunctional acrylate is preferably 4 or more, more preferably 6 or more, still more preferably 9 or more. When the number of the functional groups is 3 or less, the crosslink density of the polymer layer 3 does not increase, and the hardness may be too low, so that the rubbing resistance may not easily increase. On the other hand, if the number of functional groups of the polyfunctional acrylate is too large, the crosslink density of the polymer layer 3 increases too high, and its elasticity may be insufficient, so that the rubbing resistance may not easily increase. From such a viewpoint, a preferred upper limit of the number of functional groups of the polyfunctional acrylate is 15. Here, the number of functional groups of the polyfunctional acrylate refers to the number of acryloyl groups per molecule.

The number of ethylene oxide groups contained in the polyfunctional acrylate is preferably 3 to 15 per functional group, more preferably 4 to 12 per functional group, still more preferably 6 to 9 per functional group. If the number of the ethylene oxide groups is less than 3 per functional group, the elasticity of the polymer layer 3 may be insufficient, so that the rubbing resistance may not easily increase. If the number of the ethylene oxide groups is more than 15 per functional group, the crosslink density of the polymer layer 3 may be too low, so that the rubbing resistance may not easily increase. Here, the number of ethylene oxide groups per functional group refers to (the number of ethylene oxide groups per molecule)/(the number of acryloyl groups per molecule).

Examples of the polyfunctional acrylate include ethoxylated pentaerythritol tetraacrylate and ethoxylated polyglycerin polyacrylate. As a known example of ethoxylated pentaerythritol tetraacrylate, there is “NK ester ATM-35E” (the number of functional groups: 4, the number of ethylene oxide groups: 8.75 per functional group) from Shin-Nakamura Chemical Co., Ltd. As known examples of ethoxylated polyglycerin polyacrylate, there are “NK ECONOMER (registered trademark) A-PG5027E” (the number of functional groups: 9, the number of ethylene oxide groups: 3 per functional group) and “NK ECONOMER A-PG5054E” (the number of functional groups: 9, the number of ethylene oxide groups: 6 per functional group) from Shin-Nakamura Chemical Co., Ltd.

The content of the polyfunctional acrylate in the polymerizable composition is preferably 50 to 70% by weight, more preferably 55 to 65% by weight, still more preferably 58 to 62% by weight, when the whole amount of the polymerizable composition is regarded as 100% by weight. If the content of the polyfunctional acrylate is less than 50% by weight, the elasticity of the polymer layer 3 is reduced, so that sufficient rubbing resistance may not be obtained. If the content of the polyfunctional acrylate is higher than 70% by weight, the crosslink density of the polymer layer 3 is reduced, so that sufficient rubbing resistance may not be obtained. When the polymerizable composition contains a plurality of types of polyfunctional acrylates, the content refers to the total of the contents of the plurality of types of polyfunctional acrylates.

(B) Monofunctional Acrylate

Monofunctional acrylate refers to an acrylate having one acryloyl group per molecule. By blending the monofunctional acrylate, a compatibility between the polyfunctional acrylate and the fluorine-containing release agent containing a perfluoropolyether group increases, so that the rubbing resistance increases. In addition, curing shrinkage of the polymerizable composition is suppressed, and a cohesive force with the base material 2 increases, so that adhesiveness increases.

As the monofunctional acrylate include those having an amide group are preferably used, and examples thereof include N-acryloylmorpholine, N, N-dimethylacrylamide, N, N-diethylacrylamide, N-(2-hydroxyethyl) acrylamide, diacetone acrylamide, and N-n-butoxymethylacrylamide. As a known example of N-acryloylmorpholine, there is “ACMO (registered trademark)” from KJ Chemicals Corporation. As a known example of N, N-dimethylacrylamide, there is “DMAA (registered trademark)” from KJ Chemicals Corporation. As a known example of N, N-diethylacrylamide, there is “DEAR (registered trademark)” from KJ Chemicals Corporation. As a known example of N-(2-hydroxyethyl) acrylamide, there is “HEAR (registered trademark)” from KJ Chemicals Corporation. As a known example of diacetone acrylamide, there is “DRAM (registered trademark)” from Nippon Kasei Co., Ltd. As a known example of N-n-butoxymethylacrylamide, there is “NBMA” from MCC Unitec Co., Ltd.

The monofunctional acrylate preferably contains at least one of N-acryloylmorpholine or N, N-dimethylacrylamide. According to such a configuration, viscosity of the monofunctional acrylate is reduced, and the compatibility between the polyfunctional acrylate and the fluorine-containing release agent containing a perfluoropolyether group further increases. When the base material 2 is a triacetyl cellulose film, the adhesiveness is further improved.

The content of the monofunctional acrylate in the polymerizable composition is preferably 15 to 30% by weight, more preferably 15 to 25% by weight, still more preferably 16 to 20% by weight, when the whole amount of the polymerizable composition is regarded as 100% by weight. If the content is less than 15% by weight, smoothness is reduced, and sufficient rubbing resistance may not be obtained. The curing shrinkage of the polymerizable composition is not suppressed, and there is a possibility that the adhesiveness is reduced. If the content is higher than 30% by weight, the crosslink density of the polymer layer 3 is reduced, and sufficient rubbing resistance may not be obtained. When the polymerizable composition contains a plurality of types of monofunctional acrylates, the content refers to the total of the contents of the plurality of types of monofunctional acrylates.

(C) Fluorine-Containing Release Agent Having Perfluoropolyether Group

As known examples of the fluorine-containing release agent containing a perfluoropolyether group, there are “Optool (registered trademark) DAC” and “Optool DAC-HP” from Daikin Industries, Ltd., and “Fomblin (registered trademark) MT70” and “Fomblin AD1700” from Solvay. In a fluorine-containing release agent containing a perfluoropolyether group, fluorine atoms are easily aligned on the surface (the surface opposite to the base material 2) of the polymer layer 3. Therefore, super water repellency can be obtained by using a fluorine-containing release agent containing a perfluoropolyether group. Moreover, since smoothness can be increased, excellent rubbing resistance can be obtained.

The content of the fluorine-containing release agent containing a perfluoropolyether group in the polymerizable composition is preferably 0.01 to 5% by weight, more preferably 0.01 to 2.5% by weight, still more preferably 0.02 to 2% by weight, when the whole amount of the polymerizable composition is regarded as 100% by weight. If the content is less than 0.01% by weight, the amount of fluorine atoms aligned on the surface (the surface opposite to the base material 2) of the polymer layer 3 is too small, so that sufficient super water repellency may not be obtained. The smoothness is reduced, and as a result, the rubbing resistance may be reduced. When the content is higher than 5% by weight, a compatibility with the polyfunctional acrylate and the monofunctional acrylate becomes low, the fluorine atoms are not uniformly aligned on the surface (the surface opposite to the base material 2) of the polymer layer 3, and the super water repellency and the rubbing resistance may be reduced. When the polymerizable composition contains a plurality of types of fluorine-containing release agents, the content refers to the total of the contents of the plurality of types of fluorine-containing release agents.

(D) Other Components

The polymerizable composition may further contain a polymerization initiator. This increases curability of the polymerizable composition.

Examples of the polymerization initiator include a photopolymerization initiator and a thermal polymerization initiator, and among them, a photopolymerization initiator is preferable. The photo-polymerization initiator is active to active energy rays, and is added so as to initiate a polymerization reaction for polymerizing monomers.

Examples of the photopolymerization initiator include a radical polymerization initiator, an anionic polymerization initiator, and a cationic polymerization initiator. Examples of such a photo-polymerization initiator include acetophenones such as p-tert-butyltrichloroacetophenone, 2,2′-diethoxyacetophenone, and 2-hydroxy-2-methyl-1-phenylpropan-1-one; ketones such as benzophenone, 4,4′-bisdimethylaminobenzophenone, 2-chlorothioxanthone, 2-methylthioxanthone, 2-ethylthioxanthone, and 2-isopropylthioxanthone; benzoin ethers such as benzoin, benzoin methyl ether, benzoin isopropyl ether, and benzoin isobutyl ether; benzyl ketals such as benzyl dimethyl ketal and hydroxycyclohexyl phenyl ketone; acyl phosphine oxides such as 2,4,6-trimethylbenzoyl-diphenyl-phosphine oxide and bis(2,4,6-trimethylbenzoyl)-phenylphosphine oxide; and alkylphenones such as 1-hydroxy-cyclohexyl-phenyl-ketone. As known examples of 2,4,6-trimethylbenzoyl-diphenyl-phosphine oxide, there are “LUCIRIN (registered trademark) TPO” and “IRGACURE (registered trademark) TPO” from IGM Resins. As a known example of bis(2,4,6-trimethylbenzoyl)-phenylphosphine oxide, there is “Omnirad 819” from IGM Resins. As a known example of 1-hydroxy-cyclohexyl-phenyl-ketone, there is “Omnirad 184” from IGM Resins.

The polymerizable composition may further contain a solvent. The solvent may be contained together with an active ingredient in the above-described components (A) to (C), or may be contained separately from the above-described components (A) to (C).

Examples of the solvent include alcohols (1 to 10 carbon atoms: e.g., methanol, ethanol, n- or i-propanol, n-, sec-, or t-butanol, benzyl alcohol, and octanol), ketones (3 to 8 carbon atoms: e.g., acetone, methyl ethyl ketone, methyl isobutyl ketone, diisobutyl ketone, dibutyl ketone, and cyclohexanone), esters or ether esters (4 to 10 carbon atoms: e.g., ethyl acetate, butyl acetate, and ethyl lactate), γ-butyrolactone, ethylene glycol monomethyl acetate, propylene glycol monomethyl acetate, ethers (4 to 10 carbon atoms: e.g., EG monomethyl ether (methyl cellosolve), EG monoethyl ether (ethyl cellosolve), diethylene glycol monobutyl ether (butyl cellosolve), propylene glycol monomethyl ether), aromatic hydrocarbons (6 to 10 carbon atoms: e.g., benzene, toluene, and xylene), amides (3 to 10 carbon atoms: e.g., dimethylformamide, dimethylacetamide, and N-methylpyrrolidone), halogenated hydrocarbons (1 to 2 carbon atoms: e.g., methylene dichloride and ethylene dichloride), and petroleum-based solvents (e.g., petroleum ether and petroleum naphtha).

<Transparent Conductive Particles 11>

The transparent conductive particle 11 is smaller than the projection 4, and more specifically, has an average particle size smaller than the height and the pitch P of the projection 4. The average particle size of the transparent conductive particles 11 is preferably 2 to 50 nm, more preferably 2 to 20 nm. As shown in FIG. 1, the transparent conductive particles 11 are placed in a bottom in a recess and arranged at a position (lower position) deeper than a tip of the projection 4. That is, the tip of the projection 4 is not covered with the transparent conductive particles 11 and is exposed on an outermost surface of the super water-repellent film 1. Since a fluorine-containing release agent containing a perfluoropolyether group is present at the tip of the projection 4, the tip of the projection 4 is exposed, so that super water repellency can be obtained. In the surface of the super water-repellent film 1 on which the projection/recess structure is provided, the recesses are provided in a mesh shape, and the transparent conductive particles 11 placed in the bottom in the recess form a mesh conductive portion. By providing the mesh conductive portion, even if static electricity is generated due to friction, it is possible to prevent charging. From the above, the surface of the super water-repellent film 1 can achieve both super water repellency and antistatic properties (conductivity).

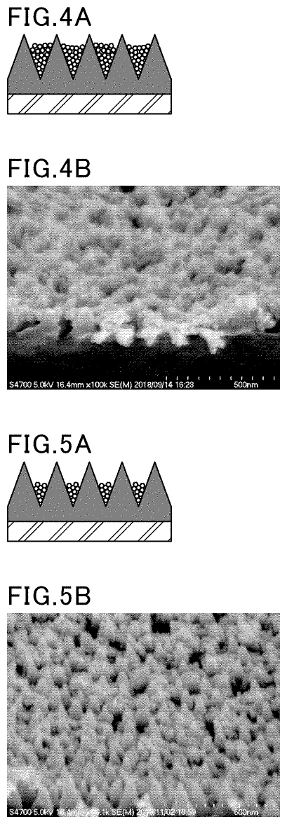

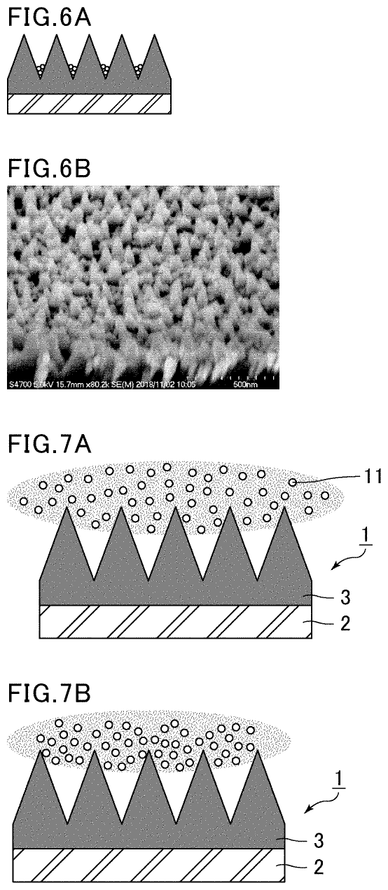

From the viewpoint of achieving both super water repellency and antistatic properties, a filling amount (thickness) d of the transparent conductive particles 11 is preferably ½ or more and ¾ or less of the height H of the projection 4. FIG. 3A is a schematic cross-sectional view showing the super water-repellent film when the filling amount d of the transparent conductive particles 11 is equal to the height H of the projection 4 (d=H), and FIG. 3B is a photomicrograph showing a surface condition of the super water-repellent film in the case shown in FIG. 3A (d=H). In the case shown in FIGS. 3A and 3B (d=H), although excellent antistatic properties are obtained, the super water repellency may not be sufficiently obtained. FIG. 4A is a schematic cross-sectional view showing the super water-repellent film when the filling amount d of the transparent conductive particles 11 is about ¾ times the height H of the projection 4 (d=¾H), and FIG. 4B is a photomicrograph showing a surface condition of the super water-repellent film in the case shown in FIG. 4A (d=¾H). In the case shown in FIGS. 4A and 4B (d=¾H), excellent antistatic properties and super water repellency can be obtained. FIG. 5A is a schematic cross-sectional view showing the super water-repellent film when the filling amount d of the transparent conductive particles 11 is about ½ times the height H of the projection 4 (d=½H), and FIG. 5B is a photomicrograph showing a surface condition of the super water-repellent film in the case shown in FIG. 5A (d=½H). In the case shown in FIGS. 5A and 5B (d=½H), excellent antistatic properties and super water repellency can be obtained. FIG. 6A is a schematic cross-sectional view showing the super water-repellent film when the filling amount d of the transparent conductive particles 11 is about ¼ times the height H of the projection 4 (d=¼H), and FIG. 6B is a photomicrograph showing a surface condition of the super water-repellent film in the case shown in FIG. 6A (d=¼H). In the case shown in FIGS. 6A and 6B (d=¼H), although excellent super water repellency is obtained, antistatic properties may not be sufficiently obtained.

The transparent conductive particles 11 are preferably formed of a material that can achieve both conductivity and transparency. The surface resistance is preferably 10³ to 10⁴Ω/□, and the transmittance is preferably 90% or more. The surface resistance and the transmittance are measured values as a solid film. The surface resistance can be measured using a surface resistance meter Hiresta-UX MCP-HT800 from Mitsubishi Chemical Analytech Co., Ltd. Examples of the material satisfying the surface resistance and the transmittance described above include indium tin oxide (ITO) and indium zinc oxide (IZO). The transparent conductive particles 11 may include a plurality of types of particles.

Since the super water-repellent film 1 has super water repellency, it can exhibit antifouling performance. The super water-repellent film 1 has transparency, anti-reflection properties, and antistatic properties. The use of the super water-repellent film 1 is not limited, but may be, for example, an optical film such as an antireflection film. Such an antireflection film contributes to improvement of the visibility when attached to the inside or outside of a display device.

A method of producing the super water-repellent film 1 is not limited, and, for example, there is a method of forming, on the surface of the base material 2, the polymer layer 3 having a projection/recess structure on its surface and provided with the projections 4, then applying a fine particle dispersion in which the transparent conductive particles 11 are dispersed in a solvent onto the surface of the polymer layer 3, and heating the laminate. A method of applying the fine particle dispersion is not limited, and, for example, a known method such as a spin coating method or a dropping method can be used. In the case of using the dropping method, the fine particle dispersion may be dropped on a part of the surface of the polymer layer 3, and the dropped fine particle dispersion may be spread over the entire surface of the polymer layer 3 by a capillary phenomenon caused by the projection/recess structure.

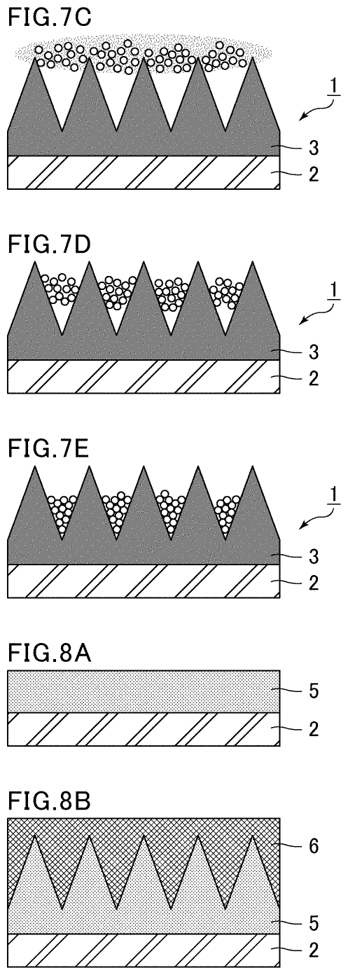

It is known that the filling of the transparent conductive particles 11 into the recess is related to surface characteristics of the polymer layer 3. In order to smoothly embed the transparent conductive particles 11 in the recess between the projections 4, it is important that the transparent conductive particles 11 are slid without adhering to the tip of the projection 4. By adding a fluorine-containing release agent containing a perfluoropolyether group, low friction resistance can be obtained, and the transparent conductive particles 11 can be smoothly embedded in the recess. Hereinafter, a mechanism in which the transparent conductive particles 11 are arranged at the bottom in the recess will be described with reference to FIGS. 7A-7E. As shown in FIG. 7A, immediately after the application, the fine particle dispersion is repelled to some extent by the polymer layer 3, and thus stays above the projection/recess structure. Then, as shown in FIG. 7B, the solvent gradually evaporates, and the transparent conductive particles 11 start to aggregate. As shown in FIG. 7C, the evaporation of the solvent proceeds, and the transparent conductive particles 11 further aggregate. As a result, as shown in FIG. 7D, the transparent conductive particles 11 start to enter into the recess due to smoothness of the surface of the polymer layer 3 (a slope of the projection 4) and the weight of the transparent conductive particles 11 due to aggregation. Finally, as shown in FIG. 7E, the transparent conductive particles 11 enter into a depth of the recess.

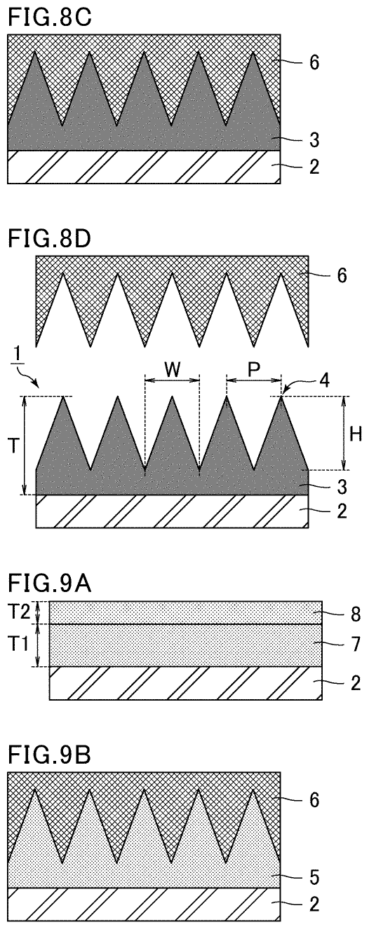

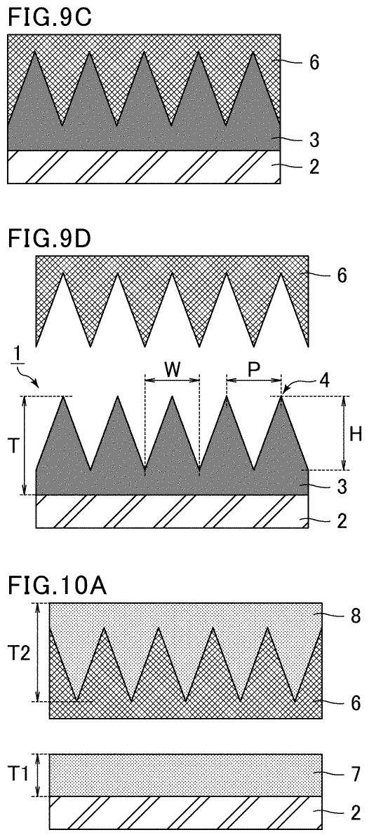

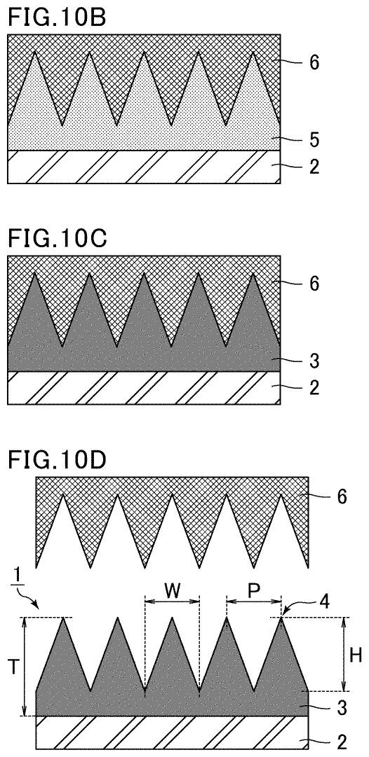

Hereinafter, a method of forming the polymer layer 3 will be described in detail with reference to FIGS. 8A to 10D. FIGS. 8A-8D are schematic cross-sectional views for explaining a first example of the method of forming the polymer layer 3. FIGS. 9A-9D are schematic cross-sectional views for explaining a second example of the method of forming the polymer layer 3. FIGS. 10A-10D are schematic cross-sectional views for explaining a third example of the method of forming the polymer layer 3.

### First Example of Method of Forming Polymer Layer 3

(Process 1)

As shown in FIG. 8A, a polymerizable composition 5 is applied on the surface of the base material 2. The polymerizable composition 5 can be applied by, for example, a spray method, a gravure method, a slot die method, a bar coat method, or the like. As a method of applying the polymerizable composition 5, in order to level film thickness and improve productivity, a gravure method or a slot die method is preferred. When the polymerizable composition 5 contains a solvent, a heat treatment (drying treatment) for removing the solvent may be performed after the application of the polymerizable composition 5. The heat treatment is preferably performed at a temperature equal to or higher than the boiling point of the solvent.

(Process 2)

As shown in FIG. 8B, the base material 2 is pressed against the die 6 with the polymerizable composition 5 interposed therebetween. As a result, a projection/recess structure is formed on the surface (the surface opposite to the base material 2) of the polymerizable composition 5.

As the die 6 having a cavity of the moth-eye structure, for example, a die produced by the following method can be used. First, a film of aluminum that is a material of the die 6 is formed on a surface of a support by sputtering. Next, the resulting aluminum layer is repetitively subjected to anodizing and etching, whereby a cavity of the moth-eye structure can be produced. At this time, the projection/recess structure of the die 6 can be modified by adjusting the duration of the anodizing and the duration of the etching.

Examples of a material of the support include glass; metal such as stainless steel and nickel; polyolefinic resins such as polypropylene, polymethylpentene, and cyclic olefinic polymers (typified by norbornene-based resin, e.g., “Zeonor (registered trademark)” from Zeon Corp., “Acton (registered trademark)” from JSR Corp.); polycarbonate resin; and resins such as polyethylene terephthalate, polyethylene naphthalate, and triacetyl cellulose. Instead of the support with an aluminum film formed on the surface, an aluminum support may be used.

The die 6 may have a shape of a flat plate or a roll, for example. The surface of the die 6 preferably has undergone release treatment. Consequently, the die 6 can be easily peeled from the polymer layer 3. Further, this treatment makes the surface free energy of the die 6 low, and thus fluorine atoms in components C and D can uniformly be aligned on the surface (the surface opposite to the base material 2) of the polymerizable composition 5 when the base material 2 is pushed to the die 6 in Process 2. Further, this treatment can prevent early removal of fluorine atoms in a fluorine-containing release agent from the surface (the surface opposite to the base material 2) of the polymerizable composition 5 before curing of the polymerizable composition 5. As a result, in the super water-repellent film 1, the fluorine atoms in the fluorine-containing release agent can uniformly be aligned on the surface (the surface opposite to the base material 2) of the polymer layer 3. Examples of a material used for the release treatment for the die 6 include fluorine-based materials, silicone-based materials, and phosphate-ester-based materials. As known examples of the fluorine-based materials, there are “Optool DSX” and “Optool AES4” from Daikin Industries, Ltd.

(Process 3)

The polymerizable composition 5 having the projection/recess structure on the surface is cured. As a result, the polymer layer 3 is formed as shown in FIG. 8C.

Examples of a method of curing the polymerizable composition 5 include a method using irradiation with active energy rays, heating, and the like. The polymerizable composition 5 is preferably cured by irradiation with active energy rays, and particularly more preferably cured by irradiation with ultraviolet rays. Irradiation with active energy rays may be performed from the base material 2 side of the polymerizable composition 5, or may be performed from the die 6 side of the polymerizable composition 5. Irradiation with active energy rays to the polymerizable composition 5 may be performed once or may be performed multiple times. The polymerizable composition 5 (Process 3) may be cured simultaneously with the formation of the projection/recess structure on the polymerizable composition 5 (Process 2).

(Process 4)

As shown in FIG. 8D, the die 6 is peeled from the polymer layer 3.

In the first example described above, for example,

Processes 1 to 4 can be continuously and efficiently performed if the base material 2 is in the form of a roll.

### Second Example of Method of Forming Polymer Layer 3

The second example is the same as the first example, except that the component of the polymerizable composition 5 is applied in separate two layers, and the two layers are then integrated with each other. Thus, descriptions of the same features are omitted as appropriate.

(Process 1)

As shown in FIG. 9A, a first resin 7 containing at least some components of the polymerizable composition 5 (for example, a polyfunctional acrylate and a monofunctional acrylate) is applied onto the surface of the base material 2. Next, a second resin 8 containing at least the remaining components of the polymerizable composition 5 (for example, a fluorine-containing release agent) is applied onto the surface (the surface opposite to the base material 2) of the applied first resin 7.

As a method of applying the first resin 7 and the second resin 8, for example, a spray method, a gravure method, a slot die method, a bar coat method, or the like may be used. As a method of applying the first resin 7, in order to level film thickness, a gravure method or a slot die method is preferred. As a method of applying the second resin 8, a spray method is preferred from the viewpoint of easily adjusting the film thickness and reducing cost relating to such a device. In the case of spray coating, a swirl nozzle, an electrostatic nozzle, or an ultrasonic nozzle is particularly preferably used.

The first resin 7 and the second resin 8 may be applied either non-simultaneously or simultaneously. An example of a method of applying the first resin 7 and the second resin 8 simultaneously is co-extruding application.

Thickness T1 of the first resin 7 is preferably 3 μm or more and 30 μm or less, more preferably 5 μm or more and 7 μm or less.

Thickness T2 of the second resin 8 is preferably 0.1 μm or more and 15 μm or less, more preferably 1 μm or more and 10 μm or less, still more preferably 2 μm or more and 8 μm or less, particularly preferably 5 μm or more and 8 μm or less.

(Process 2)

As shown in FIG. 9B, the base material 2 is pushed to the die 6 such that the first resin 7 side thereof faces the die 6 with the first resin 7 and the second resin 8 in between. As a result, the polymerizable composition 5 having a projection/recess structure on the surface (the surface opposite to the base material 2) is formed. In the polymerizable composition 5, the first resin 7 and the second resin 8 are integrated with each other and no interface exists between the resins.

(Process 3)

The polymerizable composition 5 having the projection/recess structure on the surface is cured. As a result, the polymer layer 3 is formed as shown in FIG. 9C.

(Process 4)

As shown in FIG. 9D, the die 6 is peeled from the polymer layer 3.

### Third Example of Method of Forming Polymer Layer 3

The third example is the same as the second example, except that the second resin is applied onto the surface of the die. Thus, descriptions of the same features are omitted as appropriate.

(Process 1)

As shown in FIG. 10A, the first resin 7 containing at least some components of the polymerizable composition 5 (for example, a polyfunctional acrylate and a monofunctional acrylate) is applied onto the surface of the base material 2. Next, the second resin 8 containing at least the remaining components of the polymerizable composition 5 (for example, a fluorine-containing release agent) is applied onto the surface (projection/recess surface) of the die 6. The first resin 7 and the second resin 8 may be applied either non-simultaneously or simultaneously.

(Process 2)

As shown in FIG. 10B, the base material 2 is pushed to the die 6 such that the first resin 7 side thereof faces the die 6 with the first resin 7 and the second resin 8 in between. As a result, the polymerizable composition 5 having a projection/recess structure on the surface (the surface opposite to the base material 2) is formed.

(Process 3)

The polymerizable composition 5 having the projection/recess structure on the surface is cured. As a result, the polymer layer 3 is formed as shown in FIG. 10C.

(Process 4)

As shown in FIG. 10D, the die 6 is peeled from the polymer layer 3.

In the second example and the third example, in

Process 1, the first resin 7 is applied onto the surface of the base material 2, and the second resin 8 is applied onto the surface of the first resin 7 or the die 6. However, the second resin 8 may be applied onto both surfaces of the first resin 7 and the die 6. That is, in Process 1, the first resin 7 may be applied onto the surface of the base material 2, and the second resin 8 may be applied onto at least one surface of the first resin 7 and the die 6. In Process 1, the second resin 8 may be applied onto the surface (projection/recess surface) of the die 6, and the first resin 7 may be applied onto the surface (the surface opposite to the die 6) of the second resin 8.

### EXAMPLES AND COMPARATIVE EXAMPLES

The present invention is described below in more detail based on examples and comparative examples. The examples, however, are not intended to limit the scope of the present invention.

### Example 1

A first polymerizable composition having the following composition and containing a fluorine-containing release agent containing a perfluoropolyether group (hereinafter, also referred to as “PFPE fluorine-containing release agent”) was dropped on (applied to) a TAC film and spread on the entire surface of the TAC film using a bar coater.

<Composition of First Polymerizable Composition>

(1) 78 wt % of “Miramer M282” (polyethylene glycol diacrylate) from Miwon Specialty Chemical Co., Ltd.

(2) 12 wt % of “Miramer M300” (trimethylolpropane triacrylate) from Miwon Specialty Chemical Co., Ltd.

(3) 5 wt % of “ACMO” (monofunctional acrylate: N-acryloylmorpholine) from KJ Chemicals Corporation

(4) 1 wt % of “Omnirad 819” (acylphosphine oxide photopolymerization initiator) from IGM Resins

(5) 1 wt % of “Omnirad 184” (alkylphenone-based photopolymerization initiator) from IGM Resins

(6) 3 wt % of “X71-1203E” (“PFPE fluorine-containing release agent”) from Shin-Etsu Chemical Co., Ltd.

A first die having an inverted shape of the projection/recess structure on its surface was pressed against the first polymerizable composition with a hand roller. As a result, the projection/recess structure was formed on the surface (the surface opposite to the TAC film) of the first polymerizable composition.

The first polymerizable composition having the projection/recess structure on its surface was irradiated with ultraviolet rays (dose: 200 mJ/cm²) from the TAC film side to obtain a polymer layer which was a cured product of the first polymerizable composition. Thereafter, the die was released from the polymer layer. As a result, a polymer layer including a projection/recess structure on its surface and having super water repellency was obtained. The thickness T of the polymer layer was 9.8 μm.

The surface shape of the polymer layer obtained using the first die was as follows.

Shape of projections: temple-bell-like shape

Average pitch of projections: 150 nm

Average height of projections: 200 nm

Average width of projections (half width): 70 nm

Average aspect ratio of projections (average height/average width): 2.9

The surface specifications of the polymer layer were evaluated using a scanning electron microscope “5-4700” from Hitachi High-Technologies Corp. For the evaluation, osmium (VIII) oxide (thickness: 5 nm) from Wako Pure Chemical Industries, Ltd. was applied onto the surface (the surface opposite to the TAC film) of the polymer layer using an osmium coater “Neoc-ST” from Meiwafosis Co., Ltd.

As a transparent conductive fine particle dispersion, an ITO ink (a liquid in which ITO particles were dispersed in cyclohexanone) from Maxell, Ltd. was used. The content of ITO in the ITO ink was 7.5% by weight. 5 ml of ITO ink was added dropwise and applied to the surface of the polymer layer by spin coating at 1500 rpm for 15 seconds. Thereafter, drying was performed on a hot plate at 100° C. for 10 minutes, and the ITO particles were arranged in a recess of the polymer layer. Thus, a super water-repellent film of Example 1 was completed. Table 1 below shows the production conditions of the super water-repellent film.

### Comparative Example 1

A super water-repellent film of Comparative Example 1 was produced in the same manner as in Example 1, except that the ITO ink was not applied and the ITO particles were not arranged in the recess of the polymer layer.

### Examples 2 to 4

Super water-repellent films of Examples 2 to 4 were produced in the same manner as in Example 1, except that by diluting using cyclohexanone as a solvent, the ITO content of the ITO ink was changed as shown in Table 1 below, and the filling amount of the ITO particles (the degree of embedment in the recess) was changed.

### Comparative Example 2

The die used in Comparative Example 1 was additionally subjected to anodization at 80 V for 2 minutes×4 times and etching for 20 minutes×3 times to produce a second die having a deeper recess. A 0.4% oxalic acid aqueous solution was used for anodization, and a 0.85% phosphoric acid solution was used for etching. A super water-repellent film of Comparative Example 2 was produced in the same manner as in Comparative Example 1, except that the obtained second die was pressed against the resin after the solvent was evaporated to form a polymer layer.

### Examples 5 and 6

Super water-repellent films of Examples 5 and 6 were produced in the same manner as in Example 1, except that a polymer layer was formed by pressing the second die against the first polymerizable composition after the solvent was evaporated and that by diluting using cyclohexanone as a solvent, the ITO content of the ITO ink was changed as shown in Table 1 below, and the filling amount of the ITO particles (the degree of embedment in the recess) was changed.

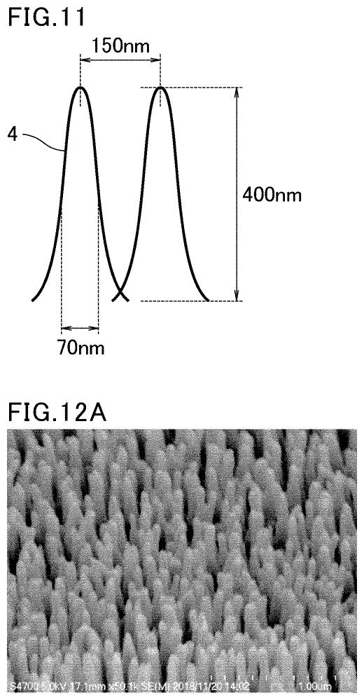

The surface shape of the polymer layer obtained using the second die was, as shown in FIG. 11, as follows.

Shape of projections: temple-bell-like shape

Average pitch of projections: 150 nm

Average height of projections: 400 nm

Average width of projections (half width): 70 nm

Average aspect ratio of projections (average height/average width): 5.7

### Comparative Example 3

A water-repellent film of Comparative Example 3 was produced in the same manner as in Comparative Example 1, except that a second polymerizable composition having the following composition and containing a fluorine-containing release agent having a perfluoroalkyl group (hereinafter, also referred to as “RF fluorine-containing release agent”) was used as a material for the polymer layer.

<Composition of Second Polymerizable Composition>

(1) 78 wt % of “Miramer M282” (polyethylene glycol diacrylate) from Miwon Specialty Chemical Co., Ltd.

(2) 12 wt % of “Miramer M300” (trimethylolpropane triacrylate) from Miwon Specialty Chemical Co., Ltd.

(3) 5 wt % of “ACMO” (monofunctional acrylate: N-acryloylmorpholine) from KJ Chemicals Corporation

(4) 1 wt % of “Omnirad 819” (acylphosphine oxide photopolymerization initiator) from IGM Resins

(5) 1 wt % of “Omnirad 184” (alkylphenone-based photopolymerization initiator) from IGM Resins

(6) 2.7 wt % of “EBECRY8110” (RF fluorine-containing release agent) from Daicel-Allnex Ltd.

(7) 0.3 wt % of “CHEMINOX FAAC-6” (RF fluorine-containing release agent) from UNIMATEC Co., Ltd.

### Comparative Examples 4 to 6

Water-repellent films of Comparative Examples 4 to 6 were produced in the same manner as in Example 1, except that the material for the polymer layer was changed to the second polymerizable composition and that by diluting using cyclohexanone as a solvent, the concentration of the ITO ink was changed as shown in Table 2 below, and the filling amount of the ITO particles (the degree of embedment in the recess) was changed.

### Comparative Example 7

A hydrophilic film of Comparative Example 7 was produced in the same manner as in Comparative Example 1, except that a third polymerizable composition having the following composition was used as a material for the polymer layer.

<Composition of Third Polymerizable Composition>

(1) 80.4 wt % of “Miramer M282” (polyethylene glycol diacrylate) from Miwon Specialty Chemical Co., Ltd.

(2) 12.4 wt % of “Miramer M300” (trimethylolpropane triacrylate) from Miwon Specialty Chemical Co., Ltd.

(3) 5.2 wt % of “ACMO” (monofunctional acrylate: N-acryloylmorpholine) from KJ Chemicals Corporation

(4) 1 wt % of “Omnirad 819” (acylphosphine oxide photopolymerization initiator) from IGM Resins

(5) 1 wt % of “Omnirad 184” (alkylphenone-based photopolymerization initiator) from IGM Resins

### Comparative Example 8 to 10

Hydrophilic films of Comparative Examples 8 to 10 were produced in the same manner as in Example 1, except that the material for the polymer layer was changed to the third polymerizable composition and that by diluting using cyclohexanone as a solvent, the concentration of the ITO ink was changed as shown in Table 3 below, and the filling amount of the ITO particles (the degree of embedment in the recess) was changed.

### [Evaluation Method]

The following evaluation was performed on the super water-repellent films, the water-repellent films, and the hydrophilic films of the example and the comparative example. The evaluation results are shown in Tables 1 to 3 below.

<Contact Angle>

As an index of super water repellency, a contact angle with pure water (water repellency) and a contact angle with hexadecane (oil repellency) were measured. Specifically, 2 μl of water or hexadecane was dropped on the surface (the surface opposite to the base material) of the polymer layer of the film, and the contact angle immediately after the dropping was measured. The measured value of the contact angle was the average value of contact angles measured at the following three points by the θ/2 method (θ/2=arctan(h/r), wherein θ: contact angle, r: radius of droplet, h: height of droplet) using a portable contact angle meter “PCA-1” from Kyowa Interface Science Co., Ltd. The first measurement point selected was the central portion of the film of each example. The second and third measurement points selected were two points that are 20 mm or more apart from the first measurement point and are point-symmetrical to each other about the first measurement point.

<Haze>

Haze was measured using a turbidimeter NDH2000 from Nippon Denshoku Industries Co., Ltd. Haze is defined by the following formula:

Haze (%)=scattered light/total light transmission×100

<Total Light Transmittance>

Haze was measured using a turbidimeter NDH2000 from Nippon Denshoku Industries Co., Ltd.

<Charge Amount>

The charge amount was first measured in a stationary state, and then a sample surface was rubbed 20 times with a gloved hand. The charge amount after rubbing was also measured. Electrostatic Fieldmeter Model 775 from ION SYSTEMS Inc. was used to measure the charge amount.

<Mechanical Properties>

(1) Friction Resistance

The film was fixed on a stage of a surface property measurement device “HEIDON-14FW” from Shinto Kagaku K.K., and the horizontal state was confirmed. After that, a probe was set on the surface (the surface opposite to the base material) of the polymer layer of the film, and the surface was rubbed once with steel wool “#0000” (from Nihon Steel Wool Co., Ltd.) with a load of 400 g. The friction resistance (unit: N) were measured. When the surface of the polymer layer was subbed with steel wool, a contact surface between the surface of the polymer layer and the steel wool was circular with a diameter of 25 mm, the stroke width was 20 mm, and the rate was 30 mm/min.

(2) Steel Wool Abrasion Resistance

The surface (the surface opposite to the base material) of the polymer layer of the film was rubbed with steel wool “#0000” (from Nihon Steel Wool Co., Ltd.) with a load of 400 g. At this time, the contact surface between the surface of the polymer layer and the steel wool was circular with a diameter of 25 mm. Then, while visual observation was performed in an environment with an illuminance of 100 1× (under a fluorescent lamp), the number of scratches “N” (unit: number) on the surface (the surface opposite to the base material) of the polymer layer of the film was counted. Rubbing with steel wool was performed using a surface property tester “HEIDON (registered trademark)-14FW” (from Shinto Scientific Co., Ltd.) as a testing device at a stroke width of 10 mm and a rate of 100 mm/s. The number of rubbing was 10 reciprocations. The evaluation criteria were as follows.

Level 10: N=0

Level 9: N=1 to 2

Level 8: N=3 to 5

Level 7: N=6 to 10

Level 6: N=11 to 15

Level 5: N=16 to 20

Level 4: N=21 to 25

Level 3: N=26 to 30

Level 2: N=31 to 35

Level 1: N≥36

TABLE 1

| | Fluorine- | Average | | | | | | Charge amount (kV) | | Mechanical properties | |
|---|---|---|---|---|---|---|---|---|---|---|---|
| | containing | aspect | | Contact angle (°) | | | Total light | | After | Friction | |
| | release | ratio of | ITO content | Pure | Hexa- | Haze | transmittance | Stationary | surface | resistance | SW abrasion |
| | agent | projections | (weight %) | water | decane | (%) | (%) | state | rubbing | (V) | resistance |
| Comparative | PFPE base | 2.9 | — | 150 or more | 101.2 | 0.89 | 96.5 | 0.30 | 2.0 | 0.9 | Level 9 |
| Example 1 | | | | | | | | | | | |
| Example 1 | PFPE base | 2.9 | 7.5 | 117.1 | 15.2 | 1.42 | 93.8 | 0.05 | 0.10 | 2.1 | Level 2 |
| Example 2 | PFPE base | 2.9 | 4.4 | 150 or more | 12.9 | 1.16 | 94.1 | 0.15 | 0.15 | 1.6 | Level 11 |
| Example 3 | PFPE base | 2.9 | 3.8 | 150 or more | 14.2 | 1.3 | 95.3 | 0.15 | 0.15 | 1.6 | Level 5 |
| Example 4 | PFPE base | 2.9 | 2.5 | 150 or more | 12.7 | 1.21 | 95.6 | 0.15 | 1.20 | 1.6 | Level 5 |
| Comparative | PFPE base | 5.7 | — | 150 or more | 95.5 | 0.85 | 96.5 | 0.30 | 2.0 | 0.9 | Level 8 |
| Example 2 | | | | | | | | | | | |
| Example 5 | PFPE base | 5.7 | 5.8 | 150 or more | 31.2 | 18.26 | 90.4 | 0.15 | 0.15 | 1.8 | Level 1 |
| Example 6 | PFPE base | 5.7 | 4.4 | 150 or more | 23.8 | 15.22 | 91.8 | 0.15 | 0.15 | 1.6 | Level 2 |

TABLE 2

| | Fluorine- | Average | | | | | | Charge amount (kV) | | Mechanical properties | |
|---|---|---|---|---|---|---|---|---|---|---|---|
| | containing | aspect | | Contact angle (°) | | | Total light | | After | Friction | |
| | release | ratio of | ITO content | Pure | Hexa- | Haze | transmittance | Stationary | surface | resistance | SW abrasion |
| | agent | projections | (weight %) | water | decane | (%) | (%) | state | rubbing | (V) | resistance |
| Comparative | RF base | 2.9 | — | 139.0 | 90.0 | 0.8 | 97.0 | 0.30 | 2.0 | 1.7 | Level 3 to 4 |
| Example 3 | | | | | | | | | | | |
| Comparative | RF base | 2.9 | 7.5 | 96.0 | 15.2 | 1.5 | 90.1 | 0.05 | 0.05 | 1.9 | Level 1 |
| Example 4 | | | | | | | | | | | |
| Comparative | RF base | 2.9 | 4.4 | 97.0 | 14.2 | 1.9 | 91.0 | 0.05 | 0.05 | 1.9 | Level 1 |
| Example 5 | | | | | | | | | | | |
| Comparative | RF base | 2.9 | 3.8 | 121.5 | 12.7 | 1.3 | 92.0 | 0.05 | 1.20 | 2.0 | Level 1 |
| Example 6 | | | | | | | | | | | |

TABLE 3

| | Fluorine- | Average | | | | | | Charge amount (kV) | | Mechanical properties | |
|---|---|---|---|---|---|---|---|---|---|---|---|
| | containing | aspect | | Contact angle (°) | | | Total light | | After | Friction | |
| | release | ratio of | ITO content | Pure | Hexa- | Haze | transmittance | Stationary | surface | resistance | SW abrasion |
| | agent | projections | (weight %) | water | decane | (%) | (%) | state | rubbing | (V) | resistance |
| Comparative | Absent | 2.9 | — | 10 or less | 10 or less | 0.8 | 96.7 | 0.30 | 2.0 | 2.0 | Level 3 to 4 |
| Example 7 | | | | | | | | | | | |
| Comparative | Absent | 2.9 | 7.5 | 107.0 | 10 or less | 1.3 | 91.2 | 0.05 | 0.05 | 2.1 | Level 1 |
| Example 8 | | | | | | | | | | | |
| Comparative | Absent | 2.9 | 4.4 | 102.0 | 10 or less | 1.4 | 88.1 | 0.05 | 0.05 | 2.1 | Level 1 |
| Example 9 | | | | | | | | | | | |
| Comparative | Absent | 2.9 | 3.8 | 98.2 | 10 or less | 1.3 | 92.0 | 0.05 | 2.0 | 2.0 | Level 1 |
| Example 10 | | | | | | | | | | | |

### [Summary of Evaluation Results]

### Examples 1 to 6 and Comparative Examples 1 and 2

The charge amounts in the stationary state were almost the same in all examples and comparative examples. However, in the super water-repellent films of Comparative Examples 1 and 2 in which the ITO ink was not applied, the charge amount after rubbing the surface increased to 2 kV, whereas in the super water-repellent films of Examples 1 to 6 in which the ITO ink was applied, the charge amount did not increase or was small, and an antistatic effect was obtained.

Next, the super water-repellent films of Examples 1 to 4 produced by applying the ITO ink using the first die are compared. The super water-repellent film of Example 1 using the ITO ink having a high ITO content had a low contact angle with pure water, high friction resistance, and a poor steel wool resistance. On the other hand, in the super water-repellent film of Example 4 using the ITO ink having a low ITO content, the charge amount after rubbing the surface slightly increased, and the antistatic effect was small.

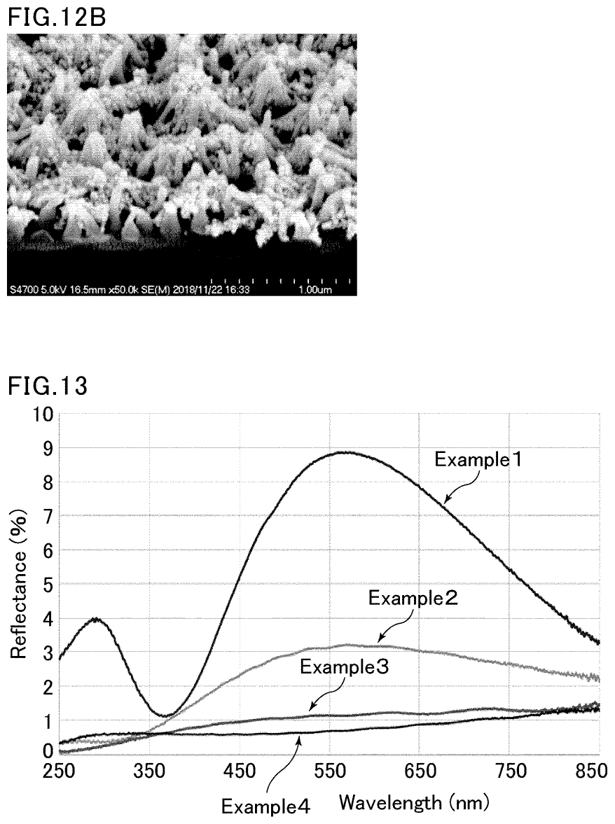

In the super water-repellent films of Examples 5 and 6 in which the second die was used and the aspect ratio of the projection of the polymer layer was as large as 5.7, sticking (adhesion between the projections) occurred after application of the ITO ink. FIG. 12A and FIG. 12B are micrographs showing surface conditions of the super water-repellent film having a projection with an aspect ratio of 5.7, FIG. 12A shows a surface condition before ITO ink application, and FIG. 12B shows a surface condition after ITO ink application. In the super water-repellent films of Examples 5 and 6, due to the effect of sticking, the haze greatly increased, and the total light transmittance greatly decreased. The mechanical properties were also deteriorated, and the super water-repellent films of Examples 5 and 6 had slightly high friction resistance and a poor steel wool resistance. On the other hand, the super water-repellent films of Examples 5 and 6 had a slightly high contact angle with hexadecane and were excellent in super water repellency.

### Comparative Examples 3 to 10

For the materials of the polymer layers used in examples and comparative examples, the contact angles with the ITO ink were as follows.

First polymerizable composition (containing PFPE fluorine-containing release agent): 78.6°

Second polymerizable composition (containing RF fluorine-containing release agent): 27.6°

Third polymerizable composition (without fluorine-containing release agent): 10.7°

In order to smoothly embed the ITO particles in the recess, it is important that the ITO particles are slid without adhering to the tip of the projection. In Examples 1 to 6, by the effect of adding the PFPE fluorine-containing release agent, low friction resistance was obtained, and the ITO particles were smoothly embedded in the recess. As a result, the conductive ITO particles are arranged at a position in the recess deeper than the tip of the projection, and the tip of the projection formed of the resin containing the PFPE fluorine-containing release agent is exposed on the outermost surface of the film, so that both super water repellency and antistatic properties can be achieved. On the other hand, in the super water-repellent films of Comparative Examples 3 to 10 using the RF fluorine-containing release agent or the resin containing no fluorine, the ITO ink adopted on the surface, and the smoothness was relatively weak (the friction resistance was relatively high), so that the ITO particles were likely to be adhered to the tip of the projection and were hard to enter into the recess.

In Comparative Examples 6 and 10 in which the ITO ink was diluted and thinned, the charge amount after rubbing the surface increased. This is considered to be because the ITO particles are not ideally buried in the recess but are aggregated on the surface, so that the ITO particles are removed during rubbing. In Comparative Examples 4, 5, 8, and 9, the water contact angle was around 100°, which was almost the same value as a solid film formed of ITO. This is probably because the ITO particles are aggregated on a moth-eye surface.

When the reflectance of the super water-repellent films of Examples 1 to 4 was measured, the results were as shown in FIG. 13. As shown in FIG. 13, the reflectance decreased in the order of Example 1, Example 2, Example 3, and Example 4, and particularly in Examples 3 and 4, excellent anti-reflection properties were obtained.

When the surface resistance of the super water-repellent films of Examples 1 to 4 and Comparative Example 1 was measured, the results were as shown below. The surface resistance was measured using a surface resistance meter Hiresta-UX MCP-HT800 from Mitsubishi Chemical Analytech Co., Ltd.

Comparative Example 1: 1×10¹⁴ to 1×10¹⁵Ω/□

Example 1: 5×10⁵ to 8×10⁶Ω/□

Example 2: 9×10⁷ to 3×10⁸Ω/□

Example 3: 5×10⁸ to 2×10⁹Ω/□

Example 4: 7×10⁹ to 5×10¹⁰Ω/□

What is claimed is:

1. A super water-repellent film comprising:
a polymer layer including, on a surface of the polymer layer, a projection/recess structure in which projections are provided at a pitch equal to or smaller than a wavelength of visible light; and
a transparent conductive particle disposed in a recess provided between the projections,
the polymer layer being a cured product of a polymerizable composition containing a polyfunctional acrylate, a monofunctional acrylate, and a fluorine-containing release agent containing a perfluoropolyether group,
the transparent conductive particle being disposed at a position in the recess deeper than tips of the projections, and the tips being exposed on an outermost surface of the super water-repellent film.

2. The super water-repellent film according to claim 1,
wherein the transparent conductive particle includes an indium tin oxide particle.

3. The super water-repellent film according to claim 1,
wherein the transparent conductive particle has an average particle size of 2 to 50 nm.

4. The super water-repellent film according to claim 1,
wherein the projections provide an average aspect ratio of 2 or more and 5 or less.

5. The super water-repellent film according to claim 1,
wherein the monofunctional acrylate contains at least one of N-acryloylmorpholine or N, N-dimethylacrylamide.
